(19) United States
(12) Patent Application Publication
(10) Pub. No.: US 2011/0035032 A1
(43) Pub. Date: Feb. 10, 2011

(54) AUDIO SIGNAL PROCESSING DEVICE

(75) Inventor: KUAN-LIN WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/566,679

(22) Filed: Sep. 25, 2009

(30) Foreign Application Priority Data
Aug. 7, 2009 (CN) 200910305365.4

(51) Int. Cl. G06F 17/00

(52) U.S. Cl. 700/94

(57) ABSTRACT

An audio signal processing device receives a first voice analog signal from a portable electronic device and a second voice analog signal of noise from outside environment, and converts the first voice analog signal and the second voice analog signal into a first voice digital signal and a second voice digital signal, respectively. The first voice digital signal and the second voice digital signal are then mixed up to obtain a third voice digital signal. The third voice digital signal is converted into a third voice analog signal outputted to an earphone. A regulator is used to adjust signal intensity of the first voice analog signal and the second voice analog signal.

### BACKGROUND

1. Technical Field

The present disclosure relates to audio devices, and particularly to an audio signal processing device.

2. Description of Related Art

A common media player, such as an moving picture experts group audio layer-3 (MP3) player, is just capable of playing audio files stored therein. For example, the common media player can be used to play music for entertainment, or can be used to play foreign language audio files for study. An earphone is generally connected to the media player for a user to listen to the audio files therein, and the earphone can also reduce or eliminate noise from outside environment. However, the user sometimes needs to hear the noise from the outside environment, for example, someone is talking to the user, then the user has to remove the earphone out from his ear to respond appropriately, which is inconvenient and troublesome.

### BRIEF DESCRIPTION OF THE DRAWINGS

FIG. 1 is a block diagram of an exemplary embodiment of an audio signal processing device, the audio signal processing device including a regulator.

FIG. 2 is a sketch view of an operating interface of the regulator in the audio signal processing device of FIG. 1.

### DETAILED DESCRIPTION

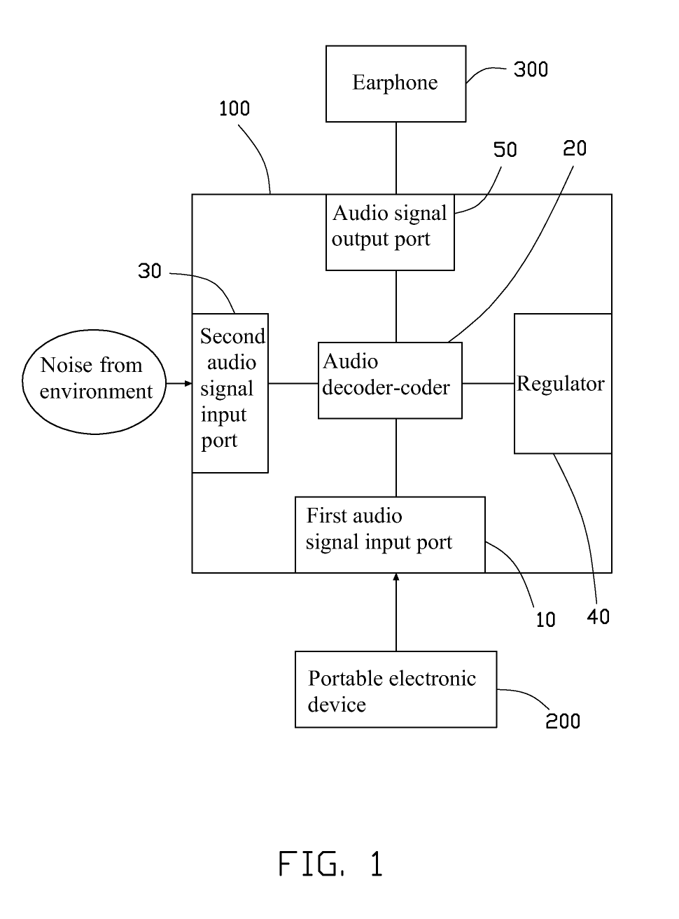

Referring to FIG. 1, an exemplary embodiment of an audio signal processing device 100 includes a first audio signal input port 10, an audio decoder-coder 20, a second audio signal input port 30, a regulator 40, and an audio signal output port 50. The audio decoder-coder 20 is connected to the first audio signal input port 10, the second audio signal input port 30, the regulator 40, and the audio signal output port 50.

The first audio signal input port 10 receives an audio signal from a portable electronic device 200, such as a moving picture experts group audio layer-3 (MP3) player. The first audio signal input port 10 and the portable electronic device 200 may be interconnected wirelessly or via electrical wires. The audio signal from the portable electronic device 200 is defined as a first voice analog signal and inputted into the first audio signal input port 10.

The second audio signal input port 30 receives noise from outside environment. In one exemplary embodiment, the second audio signal input port 30 is a mini microphone to receive the noise from outside environment. The noise from outside environment is defined as a second voice analog signal and inputted into the second audio signal input port 30.

The audio decoder-coder 20 converts the first voice analog signal into a first voice digital signal, and converts the second voice analog signal into a second voice digital signal. The first voice digital signal and the second voice digital signal are mixed up to obtain a third voice digital signal. The third voice digital signal is then converted by the audio decoder-coder 20 into a third voice analog signal and transmitted to the audio signal output port 50.

The regulator 40 modulates the signal intensity of the first voice analog signal and the second analog signal which are inputted into the audio decoder-coder 20. For example, the signal intensity of the second voice analog signal may be lessened when the noise from the outside environment is not conveying information interesting to the user, or may be enhanced when the noise from the outside environment is conveying certain information the user would like to know.

The audio signal input port 50 is connected to an earphone 300, to output the mixed third voice analog signal to the earphone 300.

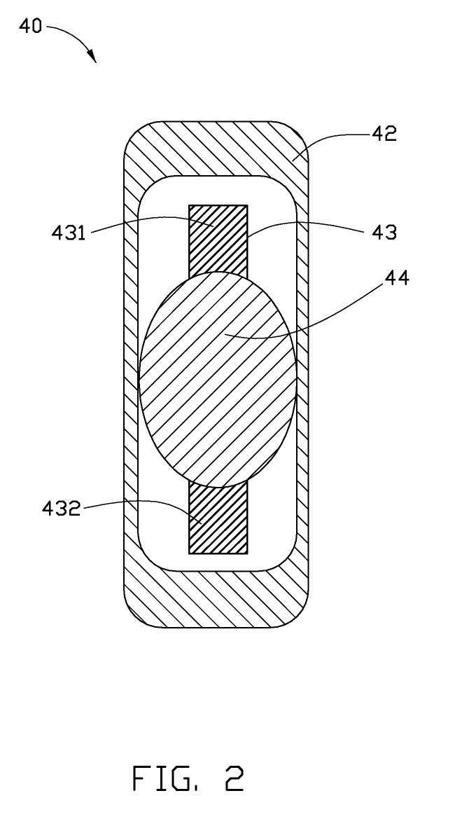

Referring to FIG. 2, the regulator 40 includes a frame 42, a variable resistor 43, and a movable button 44. The resistance of the variable resistor 43 can be adjusted via moving the movable button 44, thereby to change the signal intensity of the first voice analog signal and the second voice analog signal. Further details will be explained in further detail below.

When the movable button 44 is moved to a first end 431 of the variable resistor 43, the signal intensity of the first voice analog signal is maximally enhanced, and the signal intensity of the second voice analog signal is maximally lessened. Therefore, almost only the audio signal from the portable electronic device 200 is transmitted to the earphone 300 via the audio signal output port 50, and the noise from outside environment can not be heard via the earphone 300.

When the movable button 44 is moved to a second end 432 of the variable resistor 43, the signal intensity of the second voice analog signal is maximally enhanced, and the signal intensity of the first voice analog signal is maximally lessened. Therefore, almost only the noise from outside environment is transmitted to the earphone 300 via the audio signal output port 50, and the audio signal from the portable electronic device 200 cannot be heard via the earphone 300.

When the movable button 44 is moved to a middle of the variable resistor 43, the signal intensity of the first voice analog signal and the second voice analog signal is equal to each other. Therefore, the noise from outside environment and the audio signal from the portable electronic device 200 are both transmitted to the audio signal output port 50, and the noise from outside environment and the audio signal from the portable electronic device 200 both can be heard via the earphone 300.

The audio signal processing device 100 may be a separate body, and also can be integrated into the portable electronic device 200 or the earphone 300. Therefore, a user can hear the noise of the outside environment in need via the earphone 300, and does not need to remove the earphone 300 out from his ear.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An audio signal processing device, comprising:
a first audio signal input port to receive a first voice analog signal from a portable electronic device;
a second audio signal input port to receive a second voice analog signal of noise from outside environment;
an audio decoder-coder for converting the first voice analog signal into a first voice digital signal and converting the second voice analog signal into a second voice digital signal, mixing up the first voice digital signal and the second voice digital signal to obtain a third voice digital signal, and converting the third voice digital signal into a third voice analog signal;
a regulator for adjusting signal intensity of the first voice analog signal and the second voice analog signal; and
an audio signal output port to output the third voice analog signal to an earphone.

2. The audio signal processing device of claim 1, wherein the first audio signal input is operable to be connected to the portable electronic device via electronic wires.

3. The audio signal processing device of claim 1, wherein the first audio signal input is operable to be wirelessly connected to the portable electronic device.

4. The audio signal processing device of claim 1, wherein the second audio signal input port is a microphone.

5. The audio signal processing device of claim 1, wherein the regulator comprises a variable resistor, and a movable button for adjusting a resistance of the variable resistor, thereby to change the signal intensity of the first voice analog signal and the second voice analog signal.

6. An electronic device capable of playing media files stored therein to provide a first voice analog signal, the electronic device comprising:
a first audio signal input port for receiving the first voice analog signal;
a second audio signal input port for receiving a second voice analog signal of noise from outside environment;
an audio decoder-coder for converting the first voice analog signal into a first voice digital signal and converting the second voice analog signal into a second voice digital signal, mixing up the first voice digital signal and the second voice digital signal to obtain a third voice digital signal, and converting the third voice digital signal into a third voice analog signal;
a regulator for adjusting signal intensity of the first voice analog signal and the second voice analog signal; and
an audio signal output port to output the third voice analog signal to an earphone.

7. The electronic device of claim 6, wherein the second audio signal input port is a microphone.

8. The electronic device of claim 6, wherein the regulator comprises a variable resistor, and a movable button for adjusting a resistance of the variable resistor, thereby to change the signal intensity of the first voice analog signal and the second voice analog signal.

9. An earphone, comprising:
a first audio signal input port for receiving a first voice analog signal from a portable electronic device;
a second audio signal input port for receiving a second voice analog signal of noise from outside environment;
an audio decoder-coder for converting the first voice analog signal into a first voice digital signal and converting the second voice analog signal into a second voice digital signal, mixing up the first voice digital signal and the second voice digital signal to obtain a third voice digital signal, and converting the third voice digital signal into a third voice analog signal;
a regulator for adjusting signal intensity of the first voice analog signal and the second voice analog signal; and
an audio signal output port to output the third voice analog signal.

10. The earphone of claim 9, wherein the first audio signal input is operable to be connected to the portable electronic device via electronic wires.

11. The earphone of claim 9, wherein the first audio signal input is operable to be wirelessly connected to the portable electronic device.

12. The earphone of claim 9, wherein the second audio signal input port is a mini microphone.

13. The earphone of claim 9, wherein the regulator comprises a variable resistor, and a movable button for adjusting a resistance of the variable resistor, thereby to change the signal intensity of the first voice analog signal and the second voice analog signal.
